(19) United States
(12) Patent Application Publication
(10) Pub. No.: US 2015/0172507 A1
(43) Pub. Date: Jun. 18, 2015

(54) IMAGE COMMUNICATION APPARATUS, OPERATION METHOD, AND STORAGE MEDIUM

(71) Applicant: CANON KABUSHIKI KAISHA, Tokyo (JP)

(72) Inventors: Michio Fukushima, Yokohama-shi (JP); Eiji Ohara, Kawasaki-shi (JP); Shigeru Koizumi, Tokyo (JP); Daisuke Suga, Kawasaki-shi (JP)

(21) Appl. No.: 14/548,750

(22) Filed: Nov. 20, 2014

(30) Foreign Application Priority Data
Dec. 18, 2013 (JP) 2013-261831

(51) Int. Cl. H04N 1/327

(52) U.S. Cl. CPC H04N 1/32715

(57) ABSTRACT

There is provided with an image communication apparatus. A storage unit stores a reception mode set for each of a plurality of telephone numbers. A determination unit determines, in a case where there is an incoming call, which of the plurality of telephone numbers the incoming call is for. An operation unit operates in accordance with the reception mode stored in the storage unit that is set for the telephone number determined by the determination unit. A distinguishing unit distinguishes a type of the incoming call upon operation in accordance with the reception mode by the operation unit. A control unit controls so as to present to a user information of the incoming call that is distinguished by the distinguishing unit.

### BACKGROUND OF THE INVENTION

1. Field of the Invention

The present invention relates to an image communication apparatus, an operation method, and a storage medium.

2. Description of the Related Art

In recent years, techniques in which a service is provided over a LAN or a next generation network (NGN), replacing a conventional circuit switched public switched telephone network (PSTN) with a network based on IP technologies, are widely used. The NGN here is an IP network, provided with a bandwidth guaranteeing function and a security function for the network itself, which realizes integrally a telephone service, a video communication service, a data communication service, or the like.

Also, usage of an SIP (Session Initiation Protocol) in which a virtual session is established with a LAN or a communication device on an NGN, and a service is guaranteed while the session is established has spread (refer to Japanese Patent Laid-Open No. 2005-86724, for example). Various forms of services in which a communication device that establishes a session by the SIP, performs a call or image communication, or performs both of these simultaneously, using a protocol such as IP, VOIP (Voice Over IP), or the like, have been proposed. Furthermore, for image communication, there exists facsimile communication by an ITU-T recommendation T.38 digital facsimile procedure, for example, and facsimile communication by an ITU-T recommendation T.30 digital facsimile procedure (T.30 facsimile communication by a VoIP in-band communication).

With a FAX device (an IP-FAX device) that communicates on a LAN or an NGN, unlike with a conventional circuit switched public switched telephone network (PSTN), it is possible to perform a plurality of communications (hereinafter: sessions) on a single line simultaneously, and it becomes possible to have a plurality of telephone numbers.

Also, with a FAX apparatus connected to a conventional public switched telephone network (PSTN), a reception approach for when an incoming call is received can be selected. In such reception approaches there is a mode for receiving a FAX automatically (an automatic reception mode), for example, and there is a mode for receiving automatically in a case of a FAX, and sounding an incoming call tone in a case of a telephone (a FAX/TEL switchable mode). Furthermore, there is a mode for receiving automatically in a case of a FAX, and recording a message of another user to an answering machine in a case of a telephone (an away TEL connection mode). Furthermore, there is a mode for sounding an incoming call tone upon an incoming call for telephone or for FAX in which user picks up a telephone and handles the call manually (a manual reception mode).

A single setting of the reception mode was determined for an image communication apparatus in the case of a conventional public switched telephone network (PSTN), and because an operation required of a user when the telephone rang was determined, the user did not become confused.

### SUMMARY OF THE INVENTION

According to an embodiment, an image communication apparatus comprises: at least one telephone device; a storage unit configured to store a reception mode set for each of a plurality of telephone numbers; a determination unit configured to determine, in a case where there is an incoming call, which of the plurality of telephone numbers the incoming call is for; an operation unit configured to operate in accordance with the reception mode stored in the storage unit that is set for the telephone number determined by the determination unit; a distinguishing unit configured to distinguish a type of the incoming call upon operation in accordance with the reception mode by the operation unit; and a control unit configured to control so as to present to a user information of the incoming call that is distinguished by the distinguishing unit, wherein the image communication apparatus supports an IP network, and a call by a telephone device, and a facsimile communication are possible.

According to another embodiment, an operation method of an apparatus with at least one telephone device comprises: determining, in a case where there is an incoming call, which of a plurality of telephone numbers the incoming call is for, wherein the apparatus has a storage unit configured to store a reception mode set for each of the plurality of telephone numbers; operating in accordance with the reception mode stored in the storage unit that is set for the determined telephone number; distinguishing a type of the incoming call upon the operation in accordance with the reception mode; and presenting to a user information of the incoming call which was distinguished, wherein the apparatus supports an IP network, and a call by a telephone device, and a facsimile communication are possible.

According to still another embodiment, a non-transitory computer-readable medium stores a program for causing a computer in an apparatus with at least one telephone device to: determine, in a case where there is an incoming call, which of a plurality of telephone numbers the incoming call is for, wherein the apparatus has a storage unit configured to store a reception mode set for each of the plurality of telephone numbers; operate in accordance with the reception mode stored in the storage unit that is set for the determined telephone number; distinguish a type of the incoming call upon the operation in accordance with the reception mode; and present to a user information of the incoming call which was distinguished, wherein the apparatus supports an IP network, and a call by a telephone device, and a facsimile communication are possible.

Further features of the present invention will become apparent from the following description of exemplary embodiments (with reference to the attached drawings).

### BRIEF DESCRIPTION OF THE DRAWINGS

FIG. 1 is a block diagram for explaining a hardware configuration of an image communication apparatus corresponding to an IP-FAX according to embodiments of the present invention.

FIG. 2 is a view for illustrating an example configuration of a network in which the image communication apparatus according to embodiments is arranged.

FIG. 3 is a top view for illustrating a configuration of an operation panel of the image communication apparatus according to embodiments.

FIG. 4A is a view for illustrating a sequence for establishing an SIP session between the image forming apparatus according to the embodiment and a facsimile apparatus.

FIG. 4B is a view for illustrating a sequence for establishing an SIP session between more than one of the image communication apparatus according to the embodiment.

FIG. 5 is a view for explaining an example of an INVITE message of FIGS. 4A and 4B.

FIGS. 6A and 6B are flowcharts for describing processing for performing execution of a reception mode and a guidance of a user in the image communication apparatus according to the first embodiment.

FIG. 7A is a view for illustrating a display example of communication telephone numbers for which calls are received, reception modes, and a FAX reception start button that the image communication apparatus according to embodiments displays on a display unit of the operation panel.

FIG. 7B is a view for showing an example of a menu for setting, in step S624 of FIG. 6B, whether to perform a determination prior to a user answering a telephone device of whether the call is for FAX or for telephone when the image communication apparatus is set to a sounding setting.

FIGS. 8A and 8B are flowcharts for describing processing for performing execution of a reception mode and a guidance of a user in the image communication apparatus according to a second embodiment.

FIGS. 9A to 9C are flowcharts for describing processing for performing execution of a reception mode and a guidance of a user in the image communication apparatus according to a third embodiment of the present invention.

FIG. 10A is a view for explaining a switching button for switching a call in FIGS. 9A to 9C and a display of the switching button.

FIG. 10B is a view for illustrating an example of a conversion table used when switching of a reception mode set for a telephone number is performed in a case where in the image communication apparatus there is an incoming call during usage of the telephone device.

### DESCRIPTION OF THE EMBODIMENTS

In a case of an IP-FAX device, setting of reception modes for each of a plurality of telephone numbers allocated to the device is possible. For this reason, in a case where the telephone rings, the telephone may ring for any of a plurality of the reasons, and there is a possibility that a user will become confused because the user cannot determine why the telephone rang, or what to do next. Also, for a conventional public switched telephone network (PSTN), a plurality of sessions could not be performed simultaneously. However, with an IP-FAX, this becomes possible. For this reason, when a call was being performed in a conventional public switched telephone network (PSTN), another communication was never received, but with IP-FAX this becomes possible. For example, in a case where, during a call using a telephone device, there is an incoming call on another telephone number, it is advantageous that an operation corresponding to that incoming call can be presented to the user.

In several embodiments, a determination of the user is supported by presenting a telephone number, for which an incoming call is received, or a reception mode to the user when an incoming call is received in an image communication apparatus in which the reception mode is set for each of a plurality of telephone numbers, and this allows improvement of user convenience.

Embodiments of the present invention will be described hereinafter in detail, with reference to the accompanying drawings. It is to be understood that the following embodiments are not intended to limit the scope of the claims of the present invention, and that not all of the combinations of the aspects that are described according to the following embodiments are necessarily required to solve the problems according to the present invention.

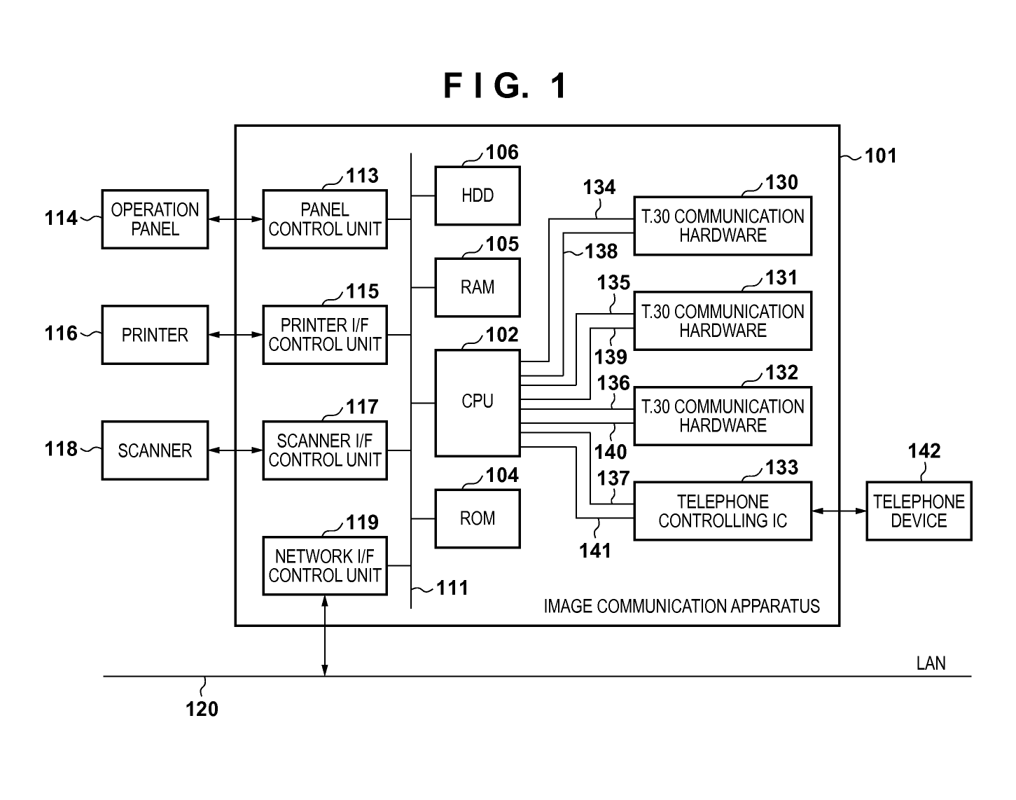

FIG. 1 is a block diagram for explaining a hardware configuration of an image communication apparatus 101 corresponding to an IP-FAX according to embodiments of the present invention.

A CPU 102 performs control of the apparatus on the whole by executing software programs of the image communication apparatus 101. Also, it performs control of connected T.30 communication hardware elements 130, 131 and 132, and a telephone controlling IC 133. A ROM 104 stores a boot program, fixed parameters, or the like, of the apparatus. A RAM 105 is used for temporary data storage when the CPU 102 controls the apparatus. An HDD 106 is a hard disk drive that stores programs and an OS that are executed by the CPU 102, and print data, and also stores various data.

A bus 111 connect a scanner I/F control unit 117, the CPU 102, the ROM 104, the RAM 105, the HDD 106, a printer I/F control unit 115, a panel control unit 113, and a network I/F control unit 119, and control signals and data signals are transmitted and received to and from the CPU 102. The panel control unit 113 controls an operation panel 114, and performs a display of various information to a display unit of the operation panel 114 and performs instruction input made by key operations on the operation panel 114 by a user. The printer I/F control unit 115 prints by outputting print data to a printer 116. The scanner I/F control unit 117 controls a scanner 118, and receives an image signal output from the scanner 118 which it outputs to the bus 111. The network I/F control unit 119 controls data transmission and receiving with a LAN 120. The LAN 120 is a local area network, for example. The T.30 communication hardware elements 130-132 are each hardware elements for performing a communication by T.30. Each of the T.30 communication hardware elements 130-132 converts digital image data received from the CPU 102 via buses 134, 135 and 136 into audio data, converts into G.711 data, and returns the result to the CPU 102 via buses 138, 139 and 140. Also, it converts G.711 data received from the CPU 102 via each of the buses 138, 139 and 140 from audio data into digital image data, and returns the result to the CPU 102 via the buses 134, 135 and 136. Note that each of the T.30 communication hardware elements 130-132 is comprised of a modem IC. The buses 134, 135 and 136 are respectively buses for transmitting and receiving digital image data between the CPU 102 and the T.30 communication hardware elements 130, 131 and 132. The buses 138, 139 and 140 are respectively buses for transmitting and receiving G.711 data (PCM conversion of audio data) between the CPU 102 and the T.30 communication hardware elements 130, 131 and 132. The telephone controlling IC 133 is controlled by the CPU 102 and a call is realized by connecting a telephone device 142. Buses 137 and 141 are buses for transmitting and receiving audio data between the CPU 102 and the telephone controlling IC 133. The telephone device 142 is a telephone device that is connected to the telephone controlling IC 133 and is capable of a call.

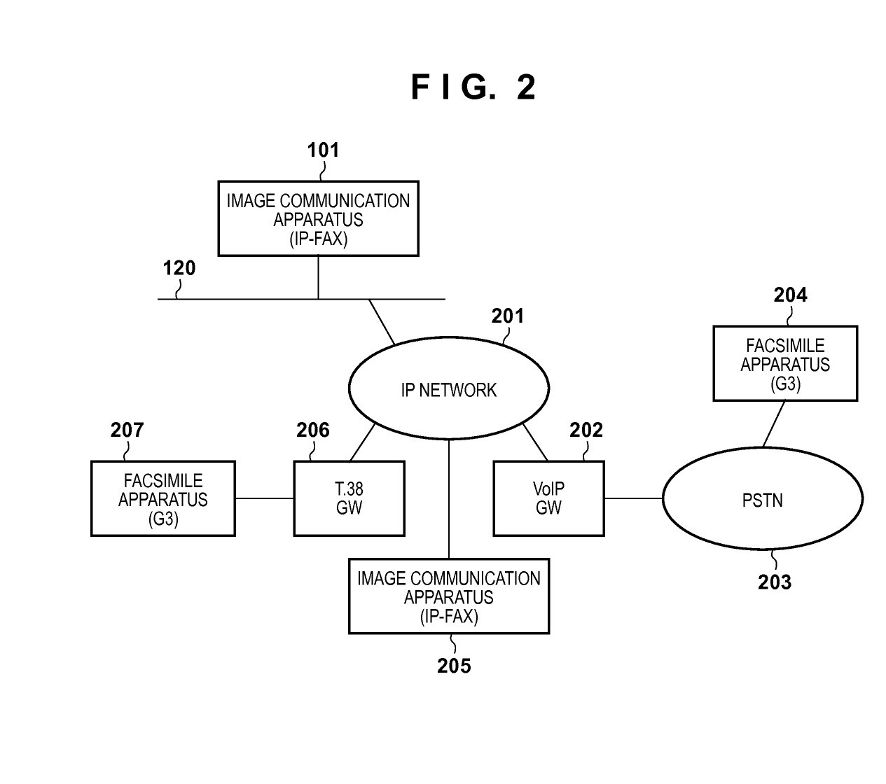

FIG. 2 is a view for illustrating an example configuration of a network in which the image communication apparatus 101 according to embodiments is arranged.

The image communication apparatus 101 is connected to an IP network 201 via the LAN 120. To the IP network 201 the image communication apparatus 101 and an image communication apparatus 205 that has a similar IP-FAX function are connected. Also there is a VoIP GW (a VoIP gateway) 202 that performs transfer of data between the IP network 201 and the PSTN 203. A PSTN 203 is a conventional public telephone line. A facsimile apparatus (G3) 204 and a facsimile apparatus (G3) 207 are facsimile apparatuses that only support T.30 audio communication. Also, to the IP network 201 a gateway (a T.38 GW) 206 that operates in accordance with a T.38 format protocol is connected.

In this network configuration, the image communication apparatus 101 is able to perform a facsimile communication by a T.38 format and a T.30 facsimile communication by an in-band communication format (hereinafter: VoIP) with the image communication apparatus 205 through the IP network 201. Also, the image communication apparatus 101, through the IP network 201, the VoIP gateway 202, and the PSTN 203, is able to perform a T.30 facsimile communication with the facsimile apparatus 204 by VoIP. Also, the image communication apparatus 101, through the IP network 201 and the T.38 gateway 206 is able to perform a G3 facsimile communication by the T.38 format with the facsimile apparatus 207. Note that upon a call of the image communication apparatus 101 operated under the network environment shown in FIG. 2, which of T.38 and VoIP is selected for the call depends on the functions supported by the receiver side that is called.

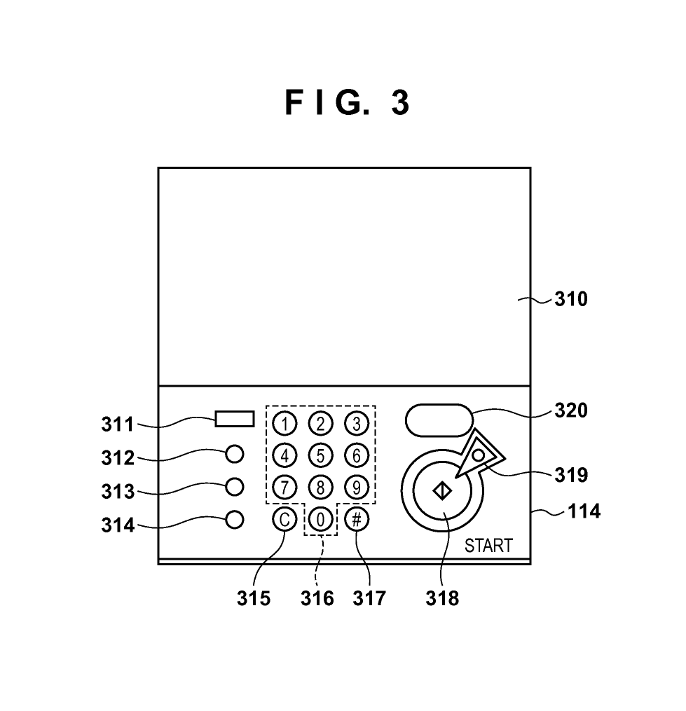

FIG. 3 is a top view illustrating a configuration of the operation panel 114 of the image communication apparatus 101 according to embodiments.

The operation panel 114 has a display unit 310, a reset key 311, a guide key 312, a user mode key 313, an interrupt key 314, a private key 315, a numeric keypad 316, a clear key 317, a start key 318, a stop key 319, and a power supply key 320.

The display unit 310 is used for displaying setting, and an operation status of the apparatus, and also setting can be input by pressing a softkey on a touch panel (not shown) mounted on the display unit 310. The reset key 311 is a key for resetting the setting to an initial mode. The guide key 312 is a key for causing a screen on which an explanation of an operation method is displayed to display on the display unit 310. The user mode key 313 is a key for entering into a mode for performing various settings on the apparatus. The interrupt key 314 is a key for causing operation of the apparatus to stop temporarily, and for causing another job operation to execute. The private key 315 is a key for, when in a password mode in which the apparatus cannot be used if password information is not input, after inputting password information using the numeric keypad 316, designating the password. The numeric keypad 316 is a key for inputting various settings values such as a number of copies or a destination number. A clear key 317 is a key for clearing input values. The start key 318 is a key for designating to the apparatus to start a copy or an image communication operation. The stop key 319 is a key for causing a currently executing operation to stop. The power supply key 320 is a soft switch, and normally this is a key for turning on/off a power source of the apparatus in software, but by long pressing the power supply key 320, for example, it is possible to turn off a main power supply of the apparatus.

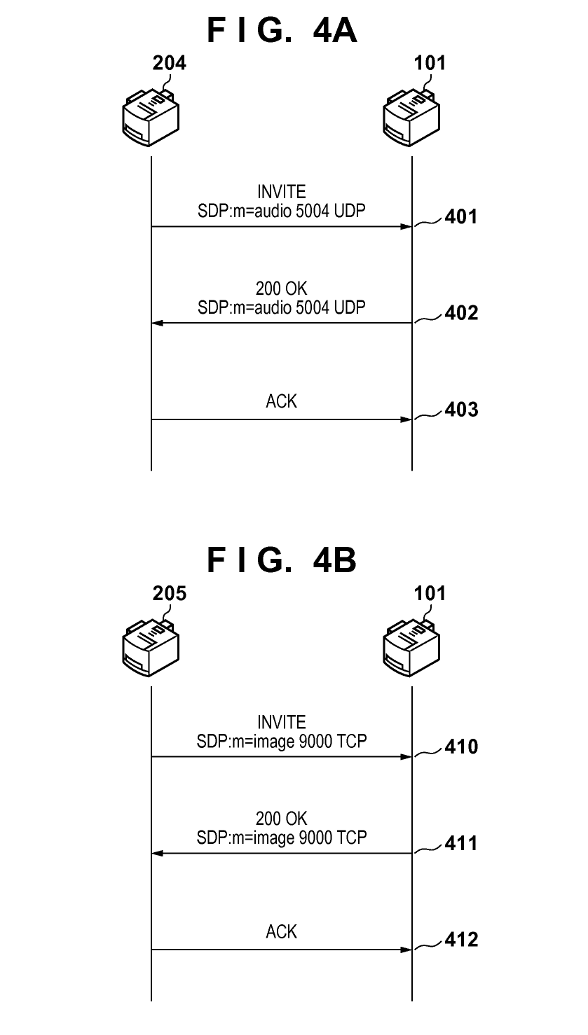

FIGS. 4A and 4B are views for explaining a sequence upon an SIP session establishment. Here explanation will be given regarding an SIP function.

FIG. 4A is a view for showing a sequence in a case where the facsimile apparatus 204 according to embodiments transmits an SIP connection request message (INVITE) including an SDP offer to the image communication apparatus 101 when the facsimile apparatus 204 desires the establishment of an SIP session with the image communication apparatus 101. In reference numeral 401, the facsimile apparatus 204 transmits the INVITE message to the image communication apparatus 101. In this INVITE message, a Session Description Protocol (hereinafter, SDP), in which media information and a reception port number that are desired to be used in the SIP session, are described, is included.

Here, in order to use telephone call or T.30 FAX communication, “m=audio 5004 UDP” is described to propose establishing an SIP session for performing data communication, using a media type (audio) and UDP port number 5004. When the image communication apparatus 101 receives the INVITE message, the destination of which is the image communication apparatus 101, the image communication apparatus 101 examines the SDP offer included in the INVITE message. Then, if media information that the image communication apparatus 101 is capable of supporting is described, a 200 OK message is transmitted in reference numeral 402. An SDP, that describes media information that the image communication apparatus 101 accepts, and a reception port number are included in the 200 OK message. In this embodiment, “m=audio 5004 UDP” is described in the 200 OK message, and so the image communication apparatus 101 consents to establishing an SIP session for performance of data communication with a media type of audio and a reception port of UDP port number 5004. When the facsimile apparatus 204 receives the 200 OK message, the facsimile apparatus 204 transmits an ACK message indicating that the 200 OK message is received in reference numeral 403. With this, an SIP session that realizes data communication of the media information between the facsimile apparatus 204 and the image communication apparatus 101, which is consented to by both parties, is established.

Note that it is possible to establish a session for a media type other than audio in this session.

FIG. 4B is a view for showing a sequence in a case where the image communication apparatus 205 according to embodiments transmits an SIP connection request message (INVITE) including an SDP offer to the image communication apparatus 101 the establishment of another an SIP session with the image communication apparatus 101 is desired.

In reference numeral 410, the image communication apparatus 205 transmits the INVITE message to the image communication apparatus 101. In this INVITE message the SDP, in which the media information and the reception port number that are desired to be used in the SIP session are described, is included. Here, to perform image communication, “m=image 9000 TCP” is described to propose establishing an SIP session for performing data communication, using an image media type and TCP port number 9000. When the image communication apparatus 101 receives the INVITE message, the destination of which is the image communication apparatus 101, the image communication apparatus 101 examines the SDP offer included in the INVITE message, and if media information that the image communication apparatus 101 is capable of supporting is described in the INVITE message, a 200 OK message is transmitted in reference numeral 411. An SDP, that describes media information that the image communication apparatus 101 accepts and a reception port number, is included in the 200 OK message. In this embodiment, m=image 9000 TCP is described, and so the image communication apparatus 101 consents to establishing an SIP session for performing data communication with a media type of image and a reception port of TCP port number 9000. When the image communication apparatus 205 receives the 200 OK message, the image communication apparatus 205 transmits an ACK message indicating that the 200 OK message is received in reference numeral 412. With this, an SIP session that realizes data communication of image media information between the image communication apparatus 205 and the image communication apparatus 101, which is consented to by both, is established.

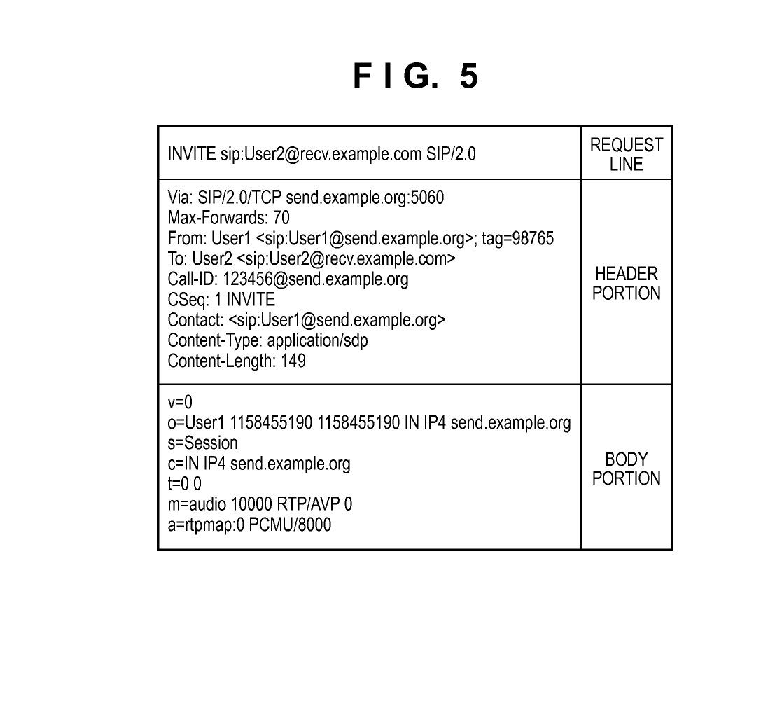

FIG. 5 is a view for explaining a detailed example of the INVITE message of FIGS. 4A and 4B.

In this INVITE message a request line, a header portion, and a body portion are included. The SDP is included in the body portion.

In the request line the following three things are included. These are a type of request (a method), a URI for indicating an address of the request, and the version of SIP. In FIG. 5 because the type of the request is INVITE, this is an INVITE. Also, the content of the request line of FIG. 5 is that the address of the request is, for example “sip:User2@recv.example.com”, and the version of SIP is “SIP/2.0”.

Next, the content shown in the header portion is explained in detail.

Information for indicating an overview of the request is included in the header portion. In this information there are listed a plurality of headers of the format of header name: value. In an SIP request, the following six headers are necessary.

(1) Via

In a Via header, the SIP version, the protocol to use for data transmission, and the partner to transmit the response in response to the request to are designated. Here the SIP version is SIP/2.0, the data transmission protocol is TCP, and the partner to whom the response is transmitted is port number 5060 of “send.example.org”, i.e. “send.example.org:5060”.

(2) Max-Forwards

In a Max-Forwards header a maximum number of times to forward the request is designated. This value is reduced by one each time the message is forwarded, and if it becomes zero, a response indicating an error is returned. This time, “70”, which is recommended in SIP, is set.

(3) From

In a From header, a sender of the request is designated. Also, a tag, which is a value for identifying the sender, is set. Here, the sender of the request is set to “User1<sip:User1@send.example.org>”, and the tag is set to “98765”.

(4) To

In a To header, a receiver of the request is designated. Here, the receiver of the request is set to “User2<sip:User2@recv.example.com>”.

(5) Call-ID

In a Call-ID header, sets an ID for identifying the SIP request/response from other calls when a sequence of calls occurs. Regarding this ID, the same one is used from the INVITE request, which is the start of the call, until the response corresponding to a BYE request, which is the end of the call. Also, it is necessary to set a unique ID which is different to other calls. Here, the ID is set to “123456@send.example.org”.

(6) CSeq

In a CSeq header a number for indicating an order of the request is set. Here it is 1.

Other than these, there are a number of headers that are not necessary. Here, explanation will be given for three of these below.

(7) Contact

In a Contact header, a transmission destination for further requests is designated by a URI. Here, the Contact header is set to “sip:User1@send.example.org”.

(8) Content-Type

In a Content-Type header a following body portion type is designated. Here, because the following body is the SDP, the Content-Type header is set to application/sdp.

(9) Content-Length

In the Content-Length header, a size of the body portion is designated. Here the body is 149 bytes (octets), and so the Content-Length header is 149.

To summarize this information, the INVITE header portion is as shown in FIG. 5.

Next explanation will be given for the body portion of FIG. 5.

By using the SDP, it is possible to describe information that identifies the session, and a data type transmitted in the session. This information is described by the format type=value. Below, examples are shown.

(1) v

v is a type that indicates the version of the protocol. Here, because SDP version 0 is used, v=0.

(2) o

o is a type indicating information for identifying the session. Here, the following information is described.

User name (a user name of a user that started this session). In FIG. 5 the user name is “User1”.

Session ID (an ID for identifying the session). The method of generating this is not established, but an approach of using a time stamp of an NTP (Network Time Protocol) format (the number of seconds accumulated since universal time coordinated, 1900, January 1, 00:00:00) has been proposed in order to avoid duplication. Here, the session ID is “1158455190”.

Session version (used to identify the version of the session when there is a change in the session, but currently it is recommended that an NTP format time stamp be used). Here, the session version is “1158455190”.

Network type (describes the type of the network. Set to IN when the Internet is used).

Address type (Describes an addressing system of the network). Set to be IP4 when IPv4 is used.

Machine address for starting the session (describes a host name (FQDN) or an IP address of the machine that started the session). Here, send.example.org is set.

To summarize the above described items, o=User1 1158455190 1158455190 IN IP4 send.example.org, as in FIG. 5.

(3) s

s is a type that indicates the a session name. The format is not established, but something is always described. Here it is Session.

(4) c

c is a type that indicates connection information. This describes a network type, an address type, a transmission source host name or an IP address. Here, c=IN IP4 send.example.org.

(5) t

t is a type that indicates a starting time and an ending time of the session. Because the SIP controls initiation/termination, these cannot be designated in the SDP. Here t=0 0

(6) m

m is a type that indicates information regarding media. Here, the following information is described.

Media type (selected from audio, video, text, application, and message based on the type of media to be transmitted). Here audio, for performing an audio communication, is designated.

Port number (describes the recipient port number when the media is received by RTP). Here it is 10000.

Protocol (describes the protocol used for a media transmission). This time, because RTP is used, RTP/AVP is set.

Format (describes a format of media to be used in accordance with a payload type described in (RFC 1890 (AV Profile))). Here it is set to 0 for a clock frequency 8 KHz μ-Law PCM setting.

To summarize the above items, m=audio 10000 RTP/AVP 0.

(7) a

a is a type that indicates various attributes. Here it is set as a=rtpmap:0 PCMU/8000 in order to indicate that the media format is μ-Law PCM 8 KHz.

To summarize this information, the body is as shown in FIG. 5.

By interpreting the header and the body portion of the INVITE shown in FIG. 5, the image communication apparatus 101 is able to identify a communication partner.

As a separate example, if “a=T38 FAX Rate management:localTFC” is described representing an attribute of the body, then it can be determined that a communication will be received from a FAX corresponding to T.38 by an incoming call from an IP network.

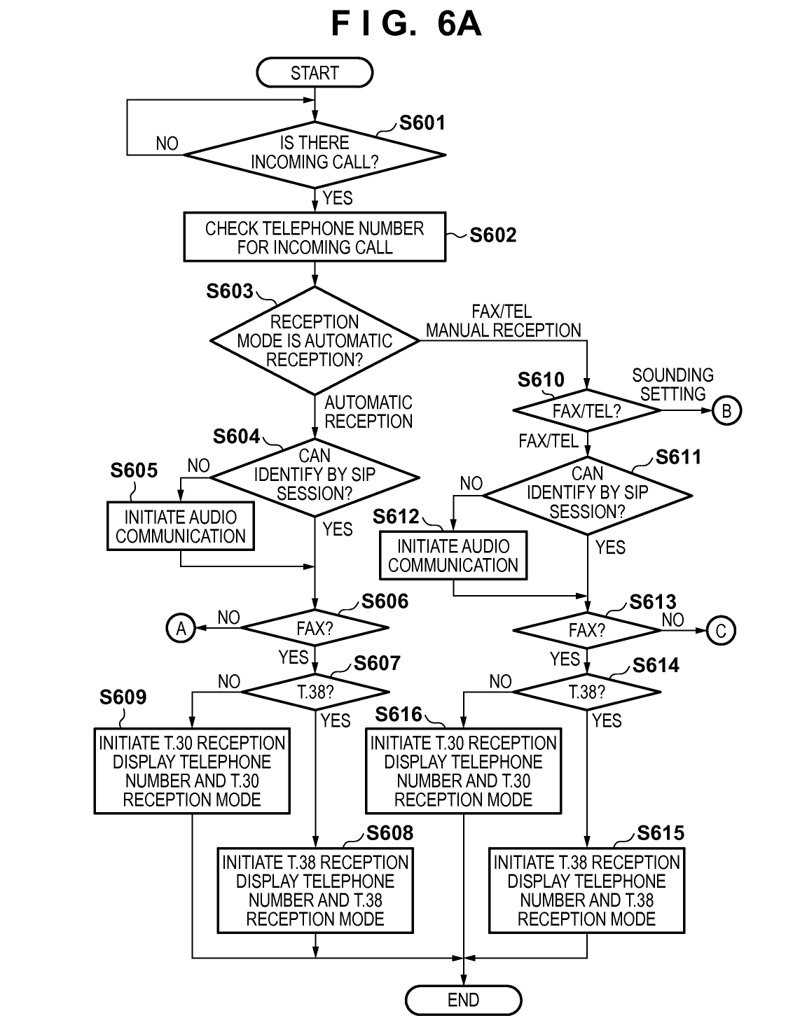

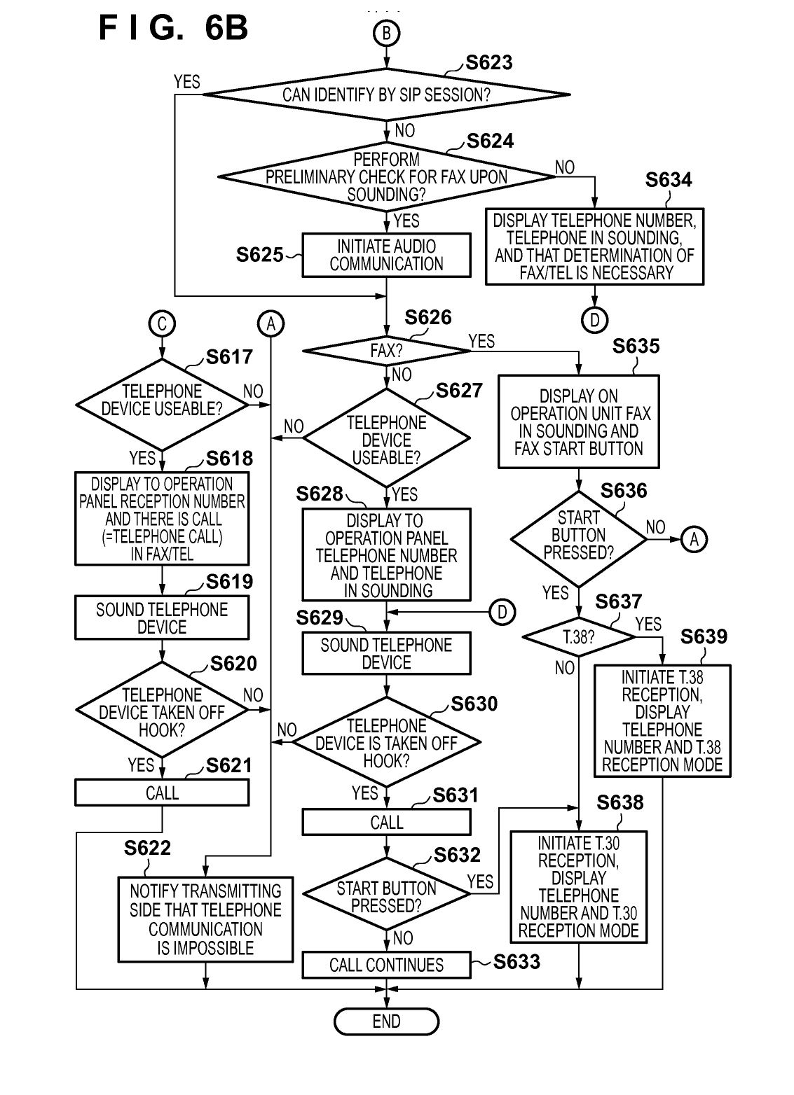

Next, with reference to FIG. 6A and FIG. 6B, explanation will be given for a display to the operation panel 114 relating to a telephone number for an incoming call and an execution of a reception mode when, in the image communication apparatus 101 according to the embodiment, there is an incoming call. Note that a program of the image communication apparatus 101 corresponding to this flowchart is installed in the HDD 106 of the image communication apparatus 101. Upon execution of this processing, this program is loaded into the RAM 105 from the HDD 106 by a boot program in the ROM 104, and executed by the CPU 102. Also, this time, an explanation regarding an away TEL connection mode is omitted, but the point that a reception mode is executed and the result is displayed to the operation panel 114 is the same.

FIG. 6A and FIG. 6B are flowcharts for describing processing for performing execution of a reception mode and a guidance of a user in the image communication apparatus according to the first embodiment.

Firstly, in step S601, the CPU 102 determines whether or not there is an incoming call. If there is no incoming call, it performs the processing of step S601 once again, and if there is an incoming call, it advances the processing to step S602. The image communication apparatus 101 has a plurality of telephone numbers, and in step S602, the CPU 102 determines the telephone number for which there is the incoming call out of the plurality of the telephone numbers, and the processing proceeds to step S603. In step S603, the CPU 102 determines whether or not the reception mode set for the telephone number for the incoming call is an automatic reception. If it does determine the reception mode to be automatic reception here, it advances the processing to step S604, and if the setting is for a FAX/TEL switchable mode or a manual reception mode, the CPU 102 advances the processing to step S610.

When the setting is the automatic reception, the CPU 102, in step S604, by analyzing the SIP session, determines whether or not it is able to identify whether or not the transmitting side is a FAX. Here, when it determines that it is possible to identify whether or not the transmitting side is a FAX, it advances the processing to step S606, and when it determines that this cannot be identified, it advances the processing to step S605. In step S605, the CPU 102 initiates an audio communication, and the processing proceeds to step S606. This is because it determines whether or not the incoming call is a FAX or a telephone by audio. In step S606, the CPU 102 determines whether or not the communication for which the incoming call is received is a FAX. When the CPU 102 determines that it is a FAX here, it advances the processing to step S607, and when it determines that it is not a FAX, it advances the processing to step S622 (FIG. 6B). In step S607, the CPU 102 determines whether the communication for which the incoming call is received is by T.38, or T.30 FAX. If it is a T.38 communication, the processing proceeds to step S608, the CPU 102 initiates T.38 reception with the transmitting side, displays, on the operation panel 114, reception mode T.38 communication, and the processing completes. On the other hand, if it determines that it is not a T.38 communication, the processing proceeds to step S609, the CPU 102 initiates with the transmitting side T.30 reception, displays the reception mode T.30 communication on the operation panel 114, and the processing completes.

Also, when the CPU 102, in step S603, determines that the reception mode is FAX/TEL, manual reception setting, the processing proceeds to step S610, and the CPU 102 determines whether or not the reception mode for the telephone number for the incoming call is FAX/TEL. In a case where it is FAX/TEL, the CPU 102 advances the processing to step S611, and in a case where it is not FAX/TEL, it advances the processing to step S623 (FIG. 6B). In step S611, the CPU 102 determines whether or not it is possible to identify whether or not the transmitting side is a FAX by analyzing the SIP session. Here, when it determines that it is possible to identify whether or not the transmitting side is a FAX, it advances the processing to step S613, and when it determines that this cannot be identified, it advances the processing to step S612. In step S612, the CPU 102 initiates an audio communication with the transmitting side, and the processing proceeds to step S613. This is because it determines whether or not the incoming call is a FAX or a telephone by audio. In step S613, the CPU 102 determines whether or not the communication for which the incoming call is received is a FAX. In a case where it determines that the communication for which the incoming call is received is a FAX, it advances the processing to step S614, and in a case where it determines that the communication is not a FAX, it advances the processing to step S617 (FIG. 6B). In step S614, the CPU 102 determines whether the communication for the incoming call is T.38 or T.30 FAX. If it determines that it is a T.38 communication, the processing proceeds to step S615, the CPU 102 initiates with the transmitting side T.38 reception processing, displays the reception mode T.38 communication on the operation panel 114, and the processing completes. Meanwhile, if the CPU 102, in step S614, determines that it is not T.38 communication, the processing proceeds to step S616, the CPU 102 initiates T.30 reception processing with the transmitting side, and displays that the communication is reception mode T.30 communication on the operation panel 114, and the processing completes.

Meanwhile, in a case where, in step S613, the CPU 102 determines that it is not a FAX, the CPU 102 determines, in step S617, whether or not the telephone device 142 is useable. Then, if it is useable, it advances the processing to step S618, and if the telephone device 142 is unusable, it advances the processing to step S622, and notifies the transmitting side that telephonic communication is impossible. In step S618, the CPU 102 displays, on the operation panel 114, that the result that it determined is that the reason the telephone device 142 rings is that there is a telephone call in FAX/TEL mode. Next, the processing proceeds to step S619, and the CPU 120 initiates a sounding of the telephone device 142, and advances the processing to step S620. In step S620, the CPU 102 determines whether or not the telephone device 142 is taken off the hook (an off-hook), and if the telephone device 142 is taken off the hook, the CPU 102 advances the processing to step S621, a call state is entered, and the processing completes. If, in step S620, the telephone device 142 is not taken off the hook even though a predetermined amount of time elapses, the CPU 102 advances the processing to step S622, and notifies the transmitting side that telephonic communication is impossible, and the processing completes.

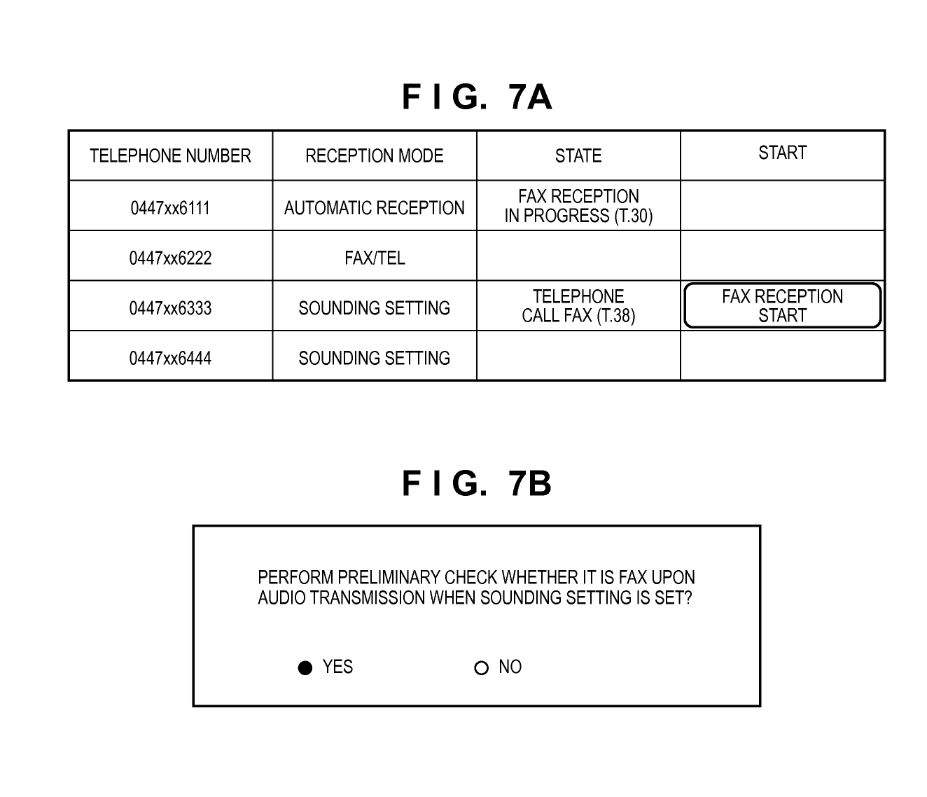

In a case where, in step S610 (FIG. 6A), it is not FAX/TEL, the CPU 102 advances the processing to step S623 (FIG. 6B), and by analyzing the SIP session, determines whether or not it is possible to identify whether the transmitting side is a FAX. Here, when it determines that it is possible to identify whether or not the transmitting side is a FAX, it advances the processing to step S626, and when it determines that this cannot be identified, it advances the processing to step S624. In step S624, the CPU 102 determines whether or not it is set to perform a preliminary check for FAX when a sounding setting is set (refer to FIG. 7B). If it is set to not perform the preliminary check, the CPU 102 advances the processing to step S634, and if it is set to perform the preliminary check, the CPU 102 advances the processing to step S625. In step S634, the CPU 102 displays to the operation panel 114 that the result that it determined is that the reason the telephone device 142 rings is that the sounding setting is set, and that it is necessary to determine whether it is FAX or TEL, and then advances the processing to step S629.

In step S625, the CPU 102 initiates an audio communication with the transmitting side, and the processing proceeds to step S626. This is because it determines whether or not the incoming call is a FAX or a telephone by audio. In step S626, the CPU 102 determines whether or not the communication for which the incoming call is received is a FAX. In a case where it determines that the communication for which the incoming call is received is FAX, it advances the processing to step S635, and in a case where it determines that the communication is not FAX, it advances the processing to step S627. In step S627, the CPU 102 determines whether or not the telephone device 142 is useable, and if the telephone device 142 is useable, the processing proceeds to step S628, the CPU 102 displays that the result that it determined is that the reason that the telephone device 142 currently rings is that the sounding setting is set and the incoming call is a telephone call, and advances the processing to step S629. In step S629 the CPU 102 sounds the telephone device 142, and the processing proceeds to step S630. In step S630, the CPU 102 determines whether or not the telephone device 142 is taken off the hook, and if the telephone device 142 is taken off the hook, the processing proceeds to step S631, and the user performs the call using the telephone device 142, and the processing proceeds to step S632. Meanwhile, if, in step S630, a predetermined amount of time has elapsed and the telephone device 142 is not taken off the hook, the CPU 102 advances the processing to step S622.

In step S632, the CPU 102 determines whether or not a FAX reception initiation instruction is performed by the user. A reception initiation by the user here may be instructed by pressing the start key 318 of the operation panel 114, or may be instructed a reception initiation start button being displayed on the display unit 310 and that start button being touched. When a FAX reception initiation is instructed in this way, the processing proceeds to step S638, and when the reception initiation is not instructed, the processing proceeds to step S633, and the call by the telephone device 142 continues, and the processing completes.

Meanwhile, in a case where, in step S626, the CPU 102 determines that it is a FAX reception, the processing proceeds to step S635. In step S635, the CPU 102 displays to the operation panel 114 the telephone number for the incoming call, that sounding setting is used, there is a FAX, and a start button by which it is possible to initiate a fax reception, and the processing advances to step S636. In step S636, the CPU 102 determines whether or not the start button is pressed by the user, and the FAX reception initiation is instructed. When the reception initiation is not instructed, the CPU 102 advances the processing to step S622, and in a case where the reception initiation is designated, the CPU 102 advances the processing to step S637. In step S637, the CPU 102 determines whether the communication for the incoming call is T.38 or T.30 FAX. When the CPU 102 determines that it is a T.38 communication, the processing proceeds to step S639, and the CPU 102 initiates T.38 reception, and displays that the reception mode is for T.38 communication on the operation panel 114, and the processing completes. Meanwhile, when the CPU 102 determines, in step S637, that it is not T.38 communication, the processing proceeds to step S638, and the CPU 102 initiates T.30 reception, and displays to the operation panel 114 that the reception mode is for T.30 communication, and the processing completes.

FIG. 7A is a view for illustrating a display example of communication telephone numbers for which calls are received, reception modes, and a FAX reception start button that the image communication apparatus 101 according to embodiments displays on the display unit 310 of the operation panel 114 in step S635 of FIG. 6B, for example.

Telephone number is a list of telephone numbers by which the image communication apparatus 101 is capable of communicating. Also reception modes set for each telephone number, and stored in memory (RAM, HDD, or the like), are shown. For example, the telephone number (0447xx6111) is set to the automatic reception, and the telephone number (0447xx6222) is set to the FAX/TEL switching. Also, the telephone numbers (0447xx6333 and 0447xx6444) are both set to the sounding setting. In the status field, the current status is shown. The status for telephone number (0447xx6111) is T.30 fax reception in progress, and the status for telephone number (0447x6333) is telephone calling in progress. Note that because for this telephone number, the call is for FAX reception, a FAX reception start button is displayed in a start field. The user, by pressing the start button, can initiate the fax reception. This corresponds to the processing of step S636 of FIG. 6B.

FIG. 7B is a view for showing an example of a menu for setting, in step S624 of FIG. 6B, whether to perform a determination prior to a user answering the telephone device 142 of whether the call is for FAX or for telephone when the image communication apparatus 101 is set to the sounding setting. In this example, with respect to whether or not to perform a preliminary check, if YES is selected, it is set so that the preliminary check is performed.

As explained above, by the first embodiment, the reception mode set for a telephone number for which an incoming call is received is determined, and if the reception mode is the automatic reception mode, it is distinguished automatically whether or not the incoming call is for FAX, and if it is a fax reception, in addition to performing a facsimile reception by T.30 or T.38, indication of that is displayed.

Meanwhile, if, in a FAX/TEL mode, it is determined that the incoming call is a fax reception, a facsimile reception is performed, and when it is TEL, the reception number, and the fact that it is a call in FAX/TEL mode is displayed, and the telephone device 142 is sounded. Also when it is a sounding setting, if a preliminary check of whether or not it is a FAX is set, it is determined whether or not it is a FAX by an audio communication, and if it is determined that it is a FAX, a start button is displayed, and if that button is pressed, the fax reception is initiated. Meanwhile, when, if the preliminary check is not set, the telephone device 142 is sounded and when the start button is pressed, transition is made to fax reception.

With this, in a state in which the telephone device is sounded, it is possible to notify the user by displaying whether the incoming call is a telephone call or a FAX. There is the effect that by displaying a button by which it is possible to transition from a state in which the telephone device is sounded, to a reception of a FAX, it is possible to make clear to the user the transition to the FAX reception.

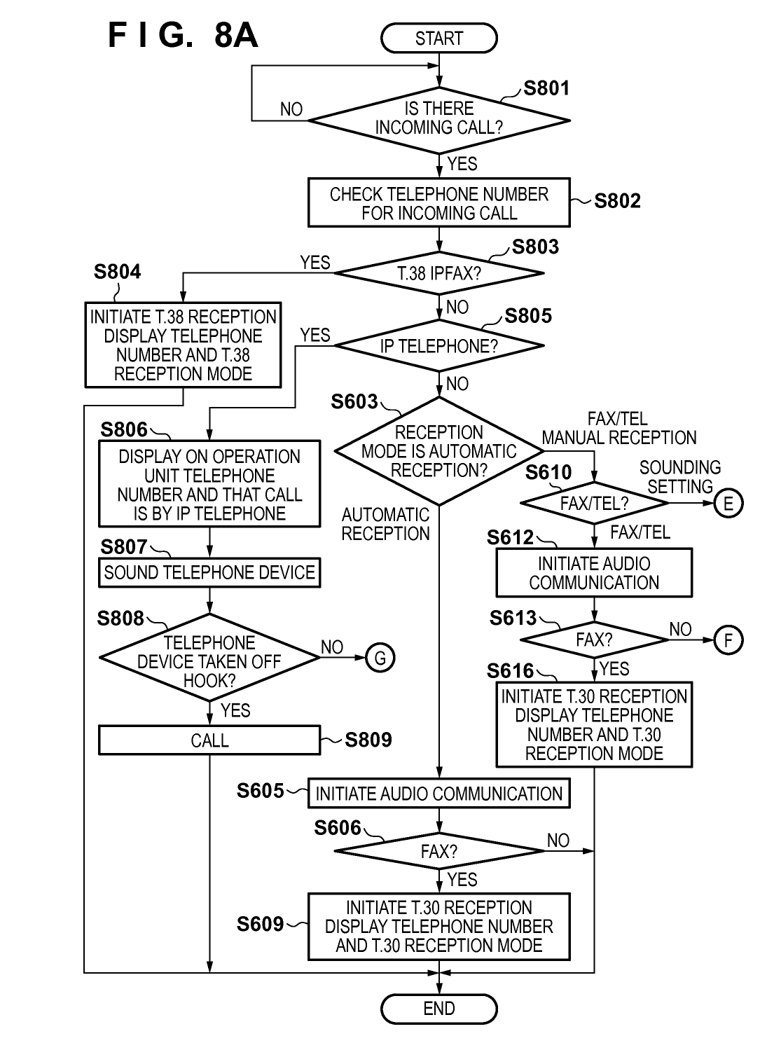

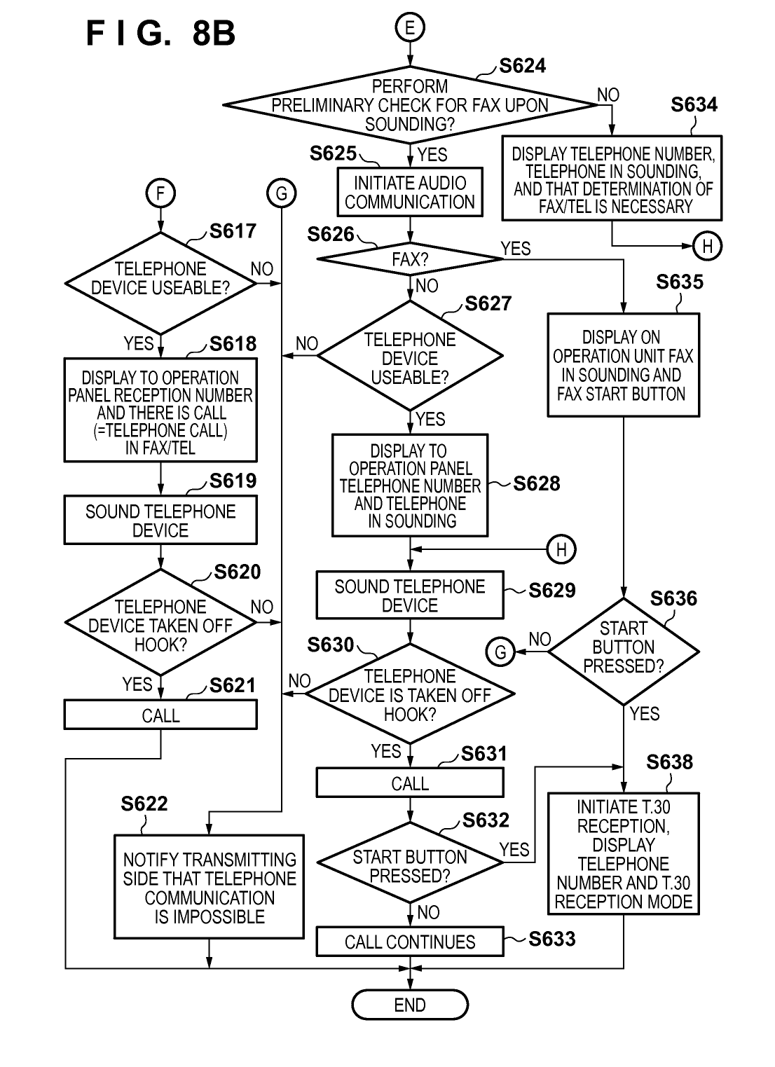

FIG. 8A and FIG. 8B are flowcharts for describing processing for performing execution in a reception mode and a guidance of a user in the image communication apparatus according to a second embodiment of the present invention.

In the second embodiment, irrespective of the reception modes set for each telephone number in the image communication apparatus 101, in a case where in the SIP session the partner can be confirmed to be a T.38 IP-FAX or an IP telephone, reception is performed if it is T.38, and a call of a telephone device is performed if it is an IP telephone. Note that a program of the image communication apparatus 101 corresponding to this flowchart is installed in the HDD 106 of the image communication apparatus 101. Upon execution of this processing, this program is loaded into the RAM 105 from the HDD 106 by a boot program in the ROM 104, and executed by the CPU 102. Note that the configuration of the image communication apparatus 101 and the system configuration according to the second embodiment are the same as those of the previously described the first embodiment, and so their explanation will be omitted.

In FIG. 8A and FIG. 8B, the step S603-step S638 is the same processing as the step S603-step S638 in the previously described FIG. 6A and FIG. 6B. Note that, the processing for identifying the communication partner in the SIP session of FIG. 6A and FIG. 6B (step S604, step S611, and step S623), the processing for confirming whether it is T.38 (step S607, step S614, and step S637), and display relating to T.38 fax reception (step S608, step S615, and step S639) are omitted in FIGS. 8A and 8B.

Firstly, in step S801, the CPU 102 determines whether or not there is an incoming call, and if there is no incoming call, once again the CPU 102 performs the processing to step S801, and if there is an incoming call the CPU 102 advances the processing to step S802. In step S802, the CPU 102 determines a telephone number for the incoming call. Next, the processing proceeds to step S803, and the CPU 102 determines whether or not it is a T.38 IP-FAX incoming call from the SIP session. Here, when it is determined that it is a T.38 incoming call, the processing proceeds to step S804, and the CPU 102 initiates T.38 reception, and displays that the reception mode is T.38 communication on the operation panel 114, and the processing completes.

Meanwhile, if it is a T.38 incoming call, the CPU 102 advances the processing to step S805. In step S805, the CPU 102 determines whether or not the received communication is IP telephone. In a case where it is determined that it is IP telephone, the processing proceeds to step S806, and the CPU 102 displays to the operation panel 114 that it is a call by IP telephone for the incoming call. Then, the processing proceeds to step S807, and the CPU 102 calls the user by sounding the telephone device 142. Next, the processing proceeds to step S808, and the CPU 102 determines whether or not the telephone device 142 is taken off the hook, and if it is taken off the hook, the processing proceeds to step S809, telephonic communication is initiated, and the processing completes. Meanwhile, in a case where the telephone device 142 is not taken off the hook even though a predetermined amount of time has elapsed in step S808, transition is made to step S622 (FIG. 8B), and the CPU 102 notifies the transmitting side that telephonic communication is impossible, and the processing completes.

As explained above, by the second embodiment, in a case where the partner in the SIP session can be confirmed to be a T.38 IP-FAX or an IP telephone, in addition to performing reception if it is T.38 and performing a call of the telephone if it is an IP telephone, it is possible to present this to the user by displaying indication of that.

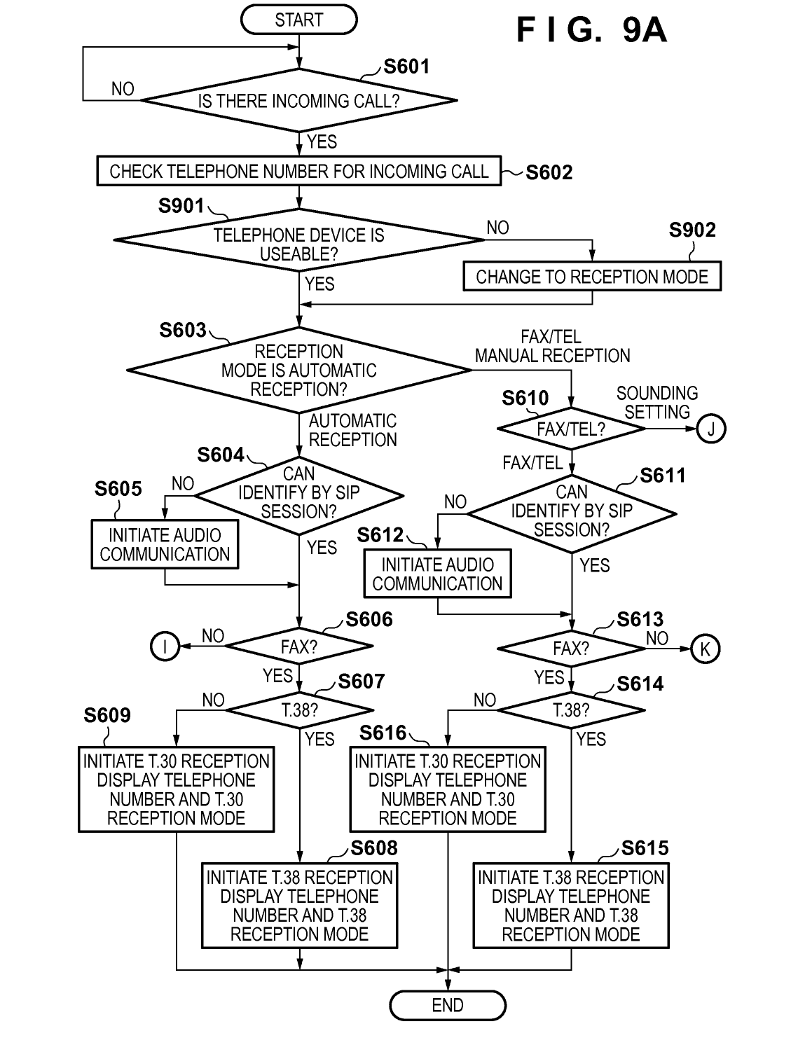

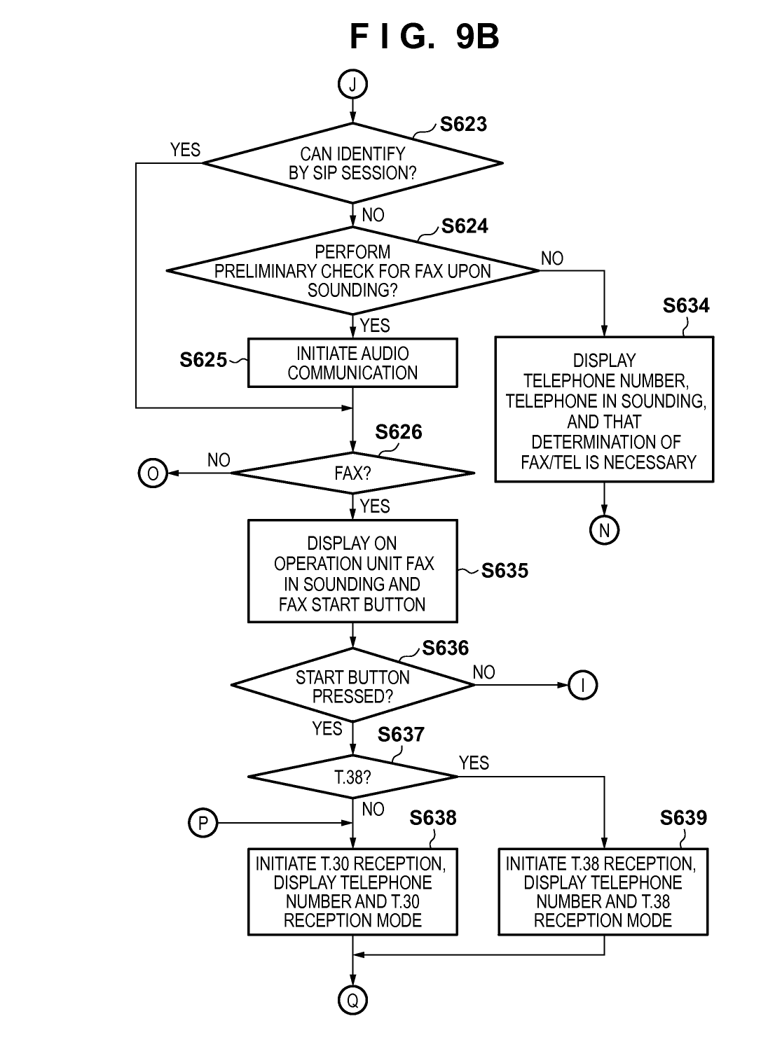

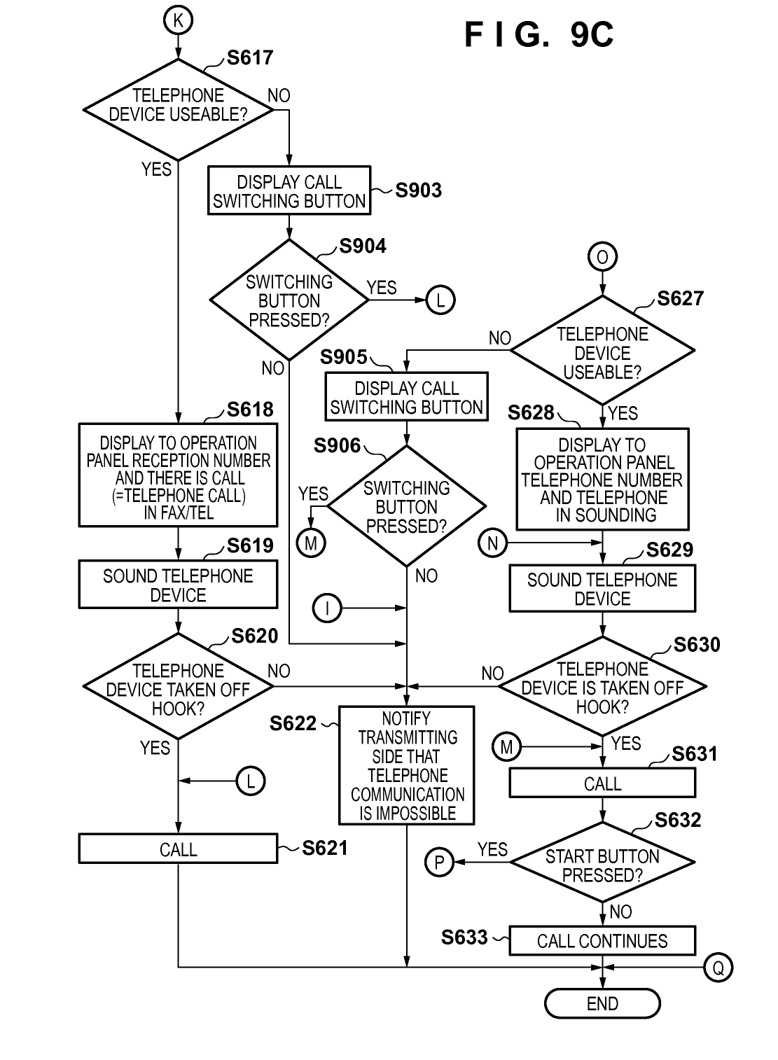

FIG. 9A to FIG. 9C are flowcharts for describing processing for performing execution of a reception mode and a guidance of a user in the image communication apparatus according to a third embodiment of the present invention. Here, configuration is taken such that, when a call is being performed by the image communication apparatus 101, the call is switched when an incoming call for which telephonic communication is required is received. Note that a program of the image communication apparatus 101 corresponding to this flowchart is installed in the HDD 106 of the image communication apparatus 101. Upon execution of this processing, this program is loaded into the RAM 105 from the HDD 106 by a boot program in the ROM 104, and executed by the CPU 102. Note that the configuration of the image communication apparatus 101 and the system configuration according to the second embodiment are the same as those of the previously described the first embodiment, and so their explanation will be omitted.

Also, regarding step S601-step S639, because the processing is the same as in FIG. 6A and FIG. 6B, explanation is omitted. Hereinafter explanation will be given regarding added step S901-step S906.

In step S901, the CPU 102 determines whether or not the telephone device 142 is useable. In a case where the telephone device 142 is usable, the processing proceeds to step S603, and if it is determined that the telephone device 142 cannot be used, the processing is advanced to step S902. In step S901, because the telephone device 142 cannot be used, the CPU 102 modifies the reception mode set for the incoming call number to the reception mode set for when there is a call, and the processing proceeds to step S603.

Also, in a case where it is determined that it is not a FAX in step S613 of FIG. 9A, the processing proceeds to step S617 (FIG. 9C), and the CPU 102 determines whether or not the telephone device 142 is useable. When it is determined that it cannot be used, the processing proceeds to step S903, and the CPU 102 displays a call switching button to the display unit 310 of the operation panel 114 so that telephone communication can be switched to the telephone number for which there is the incoming call. If, at the time, the telephone number of the partner is registered in a telephone book of the image communication apparatus 101, a registered name, or the like, may be displayed. Next, the processing proceeds to step S904, and the CPU 102 determines whether or not the call switching button displayed in step S903 is pressed. If the call switching button is pressed, the processing proceeds to step S621, and transition is made to a call using the telephone device 142. In a case where the call switching button is not pressed even though a predetermined amount of time has elapsed in step S904, the processing proceeds to step S622, and the transmitting side is notified that telephonic communication is impossible.

Also, in step S627, the CPU 102 determines whether or not the telephone device 142 is useable, and if it is determined that the telephone device 142 cannot be used, the processing proceeds to step S905. In step S905, the CPU 102 causes a call switching button to be displayed on the display unit 310 of the operation panel 114 such that telephone communication can be switched to the telephone number for which there is the incoming call. If, at the time, the telephone number of the partner is registered in a telephone book of the image communication apparatus 101, a registered name, or the like, may be displayed. Next, the processing proceeds to step S906, and the CPU 102 determines whether or not the call switching button displayed in step S905 is pressed. If it is determined that the call switching button is pressed, the processing proceeds to step S631, and transition is made to a call using the telephone device 142. Meanwhile, in a case where, in step S906, the call switching button is not pressed even though a predetermined amount of time has elapsed, the processing proceeds to step S622, and the CPU 102 notifies the transmitting side that telephonic communication is impossible, and the processing completes.

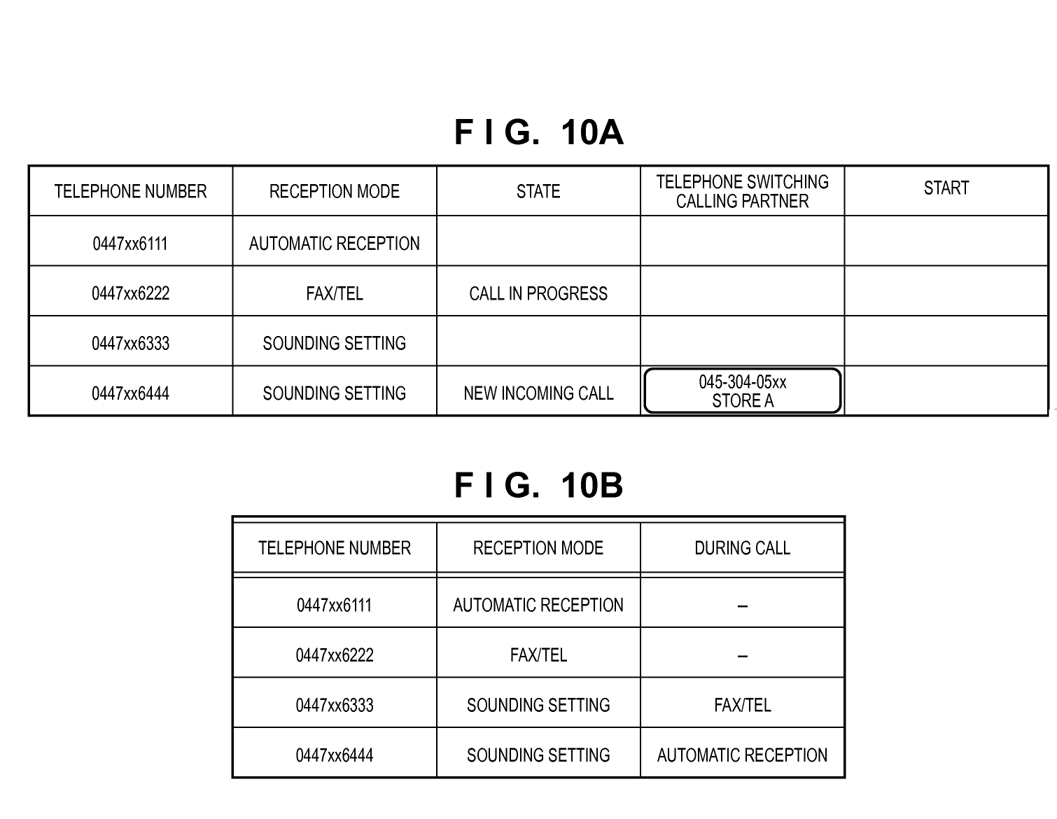

FIG. 10A is a view for explaining the call switching button explained in the flowcharts of FIG. 9A to FIG. 9C, and display thereof.

Considering the fields for the telephone number “0447xx6222” of FIG. 10A, it can be seen that a call is in progress. Also, because a display for the fields for the telephone number “0447xx6444” is set to new incoming call telephone, and for the telephone number “0447xx6222” is set to call in progress, it can be seen that the telephone device 142 cannot reply to the new incoming call. Accordingly, so that it is possible to switch the telephone call to the telephone number “0447xx6444”, a button is arranged for call switching in a TELEPHONE SWITCHING/CALLING PARTNER field. By displaying a telephone number of the partner (045-304-05xx) and a registered name (store A) registered in a telephone book on the call switching button, the for which the call is switched is displayed.

FIG. 10B is a view for illustrating an example of a conversion table used when switching of a reception mode set for a telephone number is performed in a case where in the image communication apparatus 101 there is an incoming call during usage of the telephone device 142.

For example, in the case of the telephone number “0447xx6333”, a normal reception mode is “sounding setting”, but the reception mode, in the case where the telephone device 142 is used (during a call), is FAX/TEL switching.

In this way, by the third embodiment, it is possible to register in advance how to handle a case where an incoming call for which a call is necessary is received for a case where the telephone device 142 of the image communication apparatus 101 is used and a call is in progress. With this, it is possible to cause a call switching button to be displayed on the operation panel 114 so that a connection of the telephone device 142 can be switched to a telephone number for which there is an incoming call during a call, and for a switching of a call to be performed by a button operation of a user.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-261831, filed Dec. 18, 2013, which is hereby incorporated by reference herein in its entirety.

What is claimed is:

1. An image communication apparatus comprising:
at least one telephone device;
a storage unit configured to store a reception mode set for each of a plurality of telephone numbers;
a determination unit configured to determine, in a case where there is an incoming call, which of the plurality of telephone numbers the incoming call is for;
an operation unit configured to operate in accordance with the reception mode stored in the storage unit that is set for the telephone number determined by the determination unit;
a distinguishing unit configured to distinguish a type of the incoming call upon operation in accordance with the reception mode by the operation unit; and
a control unit configured to control so as to present to a user information of the incoming call that is distinguished by the distinguishing unit,
wherein
the image communication apparatus supports an IP network, and a call by a telephone device, and a facsimile communication are possible.

2. The image communication apparatus according to claim 1, wherein the control unit, upon operation in accordance with the reception mode by the operation unit, in addition to sounding the telephone device in a case where a sounding of the telephone device is necessary, presents to a user a telephone number that the incoming call is for and the reception mode.

3. The image communication apparatus according to claim 1, wherein the reception mode includes a manual reception mode, a FAX/TEL switchable mode, and a sounding setting, and wherein the image communication apparatus further comprises a setting unit configured to set whether or not to confirm whether or not the incoming call is a FAX prior to presenting the information of the incoming call to the user in a case where the incoming call is audio upon the sounding setting.

4. The image communication apparatus according to claim 1, wherein in a case where the reception mode set for the telephone number determined by the determination unit is the manual reception mode, and the incoming call is a T.38 facsimile reception, the control unit presents to a user that the reception mode is the manual reception and that the incoming call is the T.38 facsimile reception, and presents to the user a button for initiating the T.38 facsimile communication in association with the telephone number for which the incoming call is received.

5. The image communication apparatus according to claim 1, wherein in a case where the reception mode set for the telephone number determined by the determination unit is a manual reception mode, and the incoming call requires a communication by audio, the control unit determines whether or not the incoming call is for a facsimile reception by the communication by audio, and when the incoming call is for the facsimile reception, presents to a user a button for instructing the facsimile reception.

6. The image communication apparatus according to claim 1, wherein, in a case where the reception mode set for the telephone number determined by the determination unit is a FAX/TEL switchable mode, the control unit, in addition to sounding the telephone device, presents that the sounding is performed in the FAX/TEL switchable mode in association with the telephone number for which the incoming call is received.

7. The image communication apparatus according to claim 1, further comprising a unit configured to, in a case where the incoming call is for a T.38 facsimile communication or an IP telephone, irrespective of the reception modes stored in the storage unit, perform a facsimile reception if the incoming call is the T.38 facsimile communication, and perform a call of the telephone device if the incoming call is the IP telephone.

8. The image communication apparatus according to claim 1, further comprising a modification unit configured to, in a case where there is an incoming call during a call by the telephone device, and the incoming call requires an operation by the telephone device, modify a reception mode corresponding to the telephone number for which the incoming call is received.

9. The image communication apparatus according to claim 1, wherein, in a case where there is an incoming call during a call by the telephone device, and the incoming call requires a call by the telephone device, the control unit presents a call switching button for performing a call switching for the telephone number for which the incoming call is received.

10. An operation method of an apparatus with at least one telephone device, comprising:
determining, in a case where there is an incoming call, which of a plurality of telephone numbers the incoming call is for, wherein the apparatus has a storage unit configured to store a reception mode set for each of the plurality of telephone numbers;
operating in accordance with the reception mode stored in the storage unit that is set for the determined telephone number;
distinguishing a type of the incoming call upon the operation in accordance with the reception mode; and
presenting to a user information of the incoming call which was distinguished,
wherein the apparatus supports an IP network, and a call by a telephone device, and a facsimile communication are possible.

11. A non-transitory computer-readable medium storing a program for causing a computer in an apparatus with at least one telephone device to:
determine, in a case where there is an incoming call, which of a plurality of telephone numbers the incoming call is for, wherein the apparatus has a storage unit configured to store a reception mode set for each of the plurality of telephone numbers;
operate in accordance with the reception mode stored in the storage unit that is set for the determined telephone number;
distinguish a type of the incoming call upon the operation in accordance with the reception mode; and
present to a user information of the incoming call which was distinguished,
wherein the apparatus supports an IP network, and a call by a telephone device, and a facsimile communication are possible.
